(19) United States
(12) Patent Application Publication
(10) Pub. No.: US 2015/0130609 A1
(43) Pub. Date: May 14, 2015

(54) Security condition notification system

(71) Applicant: Michael Jahangir Jacobs, Gilroy, CA (US)

(72) Inventor: Michael Jahangir Jacobs, Gilroy, CA (US)

(21) Appl. No.: 14/243,740

(22) Filed: Apr. 2, 2014

Related U.S. Application Data
(60) Provisional application No. 61/962,647, filed on Nov. 12, 2013.

(51) Int. Cl. G08B 27/00

(52) U.S. Cl. CPC G08B 27/00
USPC 340/517

(57) ABSTRACT

A security condition notification system (1, 1′, 1″) providing improved communication, in particular for emergency situations. The system (1, 1′, 1″) comprises a condition transmitter device (2, 2′, 2″, 2′″) and a condition indicator device (5, 5′). The condition transmitter device (2, 2′, 2″, 2′″) comprises at least a user interface (3, 3′), configured to enable a user to activate one of at least a first and a second security condition. The condition transmitter device (2, 2′, 2″, 2′″) further comprises a transmitter communication interface (4, 4′) connected with said user interface (3, 3′) and configured for transmitting a security notification signal corresponding to the activated security condition to said condition indicator device (5, 5′). The condition indicator device (5, 5′) is configured to receive said security notification signal and comprises at least an indicator module (7,7′), configured to display the security condition of said condition transmitter device (2, 2′, 2″, 2′″), activated by the user.

### CROSS-REFERENCE TO RELATED APPLICATION

The present utility patent application claims the priority benefit of US provisional application for patent Ser. No. 61/962,647, entitled “Safeschoolz notifier system” filed on Nov. 12, 2013. The contents of said provisional patent application are incorporated herein by reference for all purposes to the extent that such subject matter is not inconsistent herewith or limiting hereof.

### TECHNICAL FIELD

The present invention relates to the field of security and in particular to security notification and communication, for example during a so-called “lockdown” event in a private or public building, e.g. in a school, hospital or other private, public, or government building.

### BACKGROUND

In recent years, security protocols have been established to protect persons in public buildings, such as for example students and teachers in public schools. In certain potentially dangerous situations, security personnel may order a so-called “lockdown” or “emergency lockdown”, during which students and teachers are supposed to immediately lock doors and windows in the respective location to increase their safety, e.g. in case of an active shooter or terrorism situation.

Although the specific process to be followed during a lockdown depends on the guidelines as set out by the respective school district, it typically is problematic for security personnel to assess and control the situation.

Accordingly, a system and method is needed to facilitate response and assistance in emergency situations and in particular during a lockdown.

### SUMMARY OF THE INVENTION

The following summary of the present invention is provided to facilitate an understanding of some of the innovative features unique to the present invention and is not intended to be a full description. A full appreciation of the various aspects of the invention can be gained by taking the entire specification, claims, drawings, and abstract as a whole.

According to one aspect of the present invention, a security condition notification system is provided, comprising at least a condition transmitter device and a condition indicator device.

In one non-limiting example, the condition transmitter device comprises at least a user interface, which may be configured to allow a user to activate or enable one of at least a first and a second security condition. The condition transmitter device further comprises a transmitter communication interface, connected with said user interface and configured for transmitting a security notification signal corresponding to the activated security condition to said condition indicator device. An exemplary condition indicator device is configured for receiving said security notification signal and comprises at least an indicator module, configured to display the security condition of said condition transmitter, activated by the user.

In another aspect, a method of security condition notification with at least a condition transmitter device and a condition indicator device is provided. The method according to one non-limiting example comprises transmitting a security notification signal by the condition transmitter device upon activation of one of at least a first and a second security condition by a user, wherein the security notification signal corresponds to the security condition activated by the user. The method further comprises receiving the security notification signal by said condition indicator device and displaying the security condition of said condition transmitter by the condition indicator device.

The basic idea of one or more embodiments of the present invention is to provide a system and corresponding methods, which enable at least a visible line of communication for the respective security condition of a specific location and which may be advantageous in particular in emergency situations, such as terrorism. For example and in the case of a “lockdown” in a school, the system and methods provide a line of communication among students and teachers, inside a room or building, with security personnel outside the respective room or building.

The invention is based on the present inventor's recognition that a faster and more effective response by security guards, law enforcement or other authorities, collectively “security personnel” hereinafter, is possible by improving the communication of the condition of a room or building in an emergency situation. Certainly, the system and method may also be used during “non emergency” situations, such as drills, e.g., so-called “code red drills”.

In the following explanation of the present invention according to the embodiments described, the terms “connected to” or “connected with” are used to indicate a data connection and/or transmission link between at least two components, devices, elements, interfaces, units or modules. Such connection may be direct or indirect, i.e. over intermediate components, devices, elements, interfaces, units and/or modules, and may be wired or wireless.

For example, a connection may be provided over a local area network (LAN), a wide area network (WAN), cellular network, Bluetooth network, Zigbee network and/or Wi-Fi Network using a corresponding communications protocol, such as the Internet Protocol.

It is noted that the terms “location”, “room”, “premises” or “space” are used interchangeably in the present specification to denote a specific space of a building. In conjunction with school security and safety, the above terms may, e.g., relate to a classroom, office, auditorium, conference room, gym, cafeteria, hallway, multi-purpose room, restroom or other any room of a school.

In the context of the present invention, the term “security condition” relates to any security or safety condition or status applicable to a respective location, where the inventive system is used. For example, one of the security conditions may correspond to a “Red Alert Status”, representing a dangerous or unsafe situation. In another example, one of the security conditions may correspond to a “Green Alert Status”, representing a safe situation.

In another example and in the context of school security and safety, the first security condition may relate to a “Red Alert Status”, indicating that there is a problem within the respective location, requiring assistance, such as, e.g., an injured student. In a further example in the context of school security and safety, the second security condition may relate to a “Green Alert Status”, indicating that the respective location is safe and that the presence of all students is checked, i.e., that all students are accounted for.

According to an aspect of the invention, the security condition notification system comprises at least a condition transmitter device and a condition indicator device. Both the condition transmitter device and the condition indicator device may be of any suitable type to communicate the aforesaid security conditions between two distinct locations, such as from the inside of a room or building to the outside of the respective room or building. Accordingly, the condition transmitter device and the condition indicator device may in one embodiment be configured to be arranged spaced from each other.

The condition transmitter device comprises at least a user interface and a transmitter communication interface, connected with said user interface.

The user interface may be of any suitable type to allow a user to activate one of at least said first and second security condition. The user interface may thus for example comprise one or more corresponding buttons, switches, such as key or rocker switches, a touch screen display, keypad or keyboard or other suitable actuators enabling a user to select at least said first or said second security condition. The user interface in one additional or alternative embodiment may comprise one or more indicators, such as LED lights or a display, to allow the user to verify the selected security condition.

The transmitter communication interface may be of any suitable type to receive information on the selected security condition from the connected user interface and to provide the security notification signal to the condition indicator device. The security notification signal corresponds to the security condition, selected by the user. Since the present security condition notification system may be used for emergency notification only, a user may not select a security condition during “non-emergency” times. The condition transmitter may in one embodiment thus be configured to provide a security notification signal corresponding to a “no condition set” or “condition clear” state in case none of the security conditions is activated by the user. Alternatively, the transmitter communication interface may be configured to not provide a security notification signal in this case.

As discussed in the preceding, the condition indicator device is configured for receiving said security notification signal from the condition transmitter device, and comprises at least an indicator module. The indicator module is configured to at least display the security condition, as set by the user with the user interface of the condition transmitter device. The indicator module may thus comprise for example one or more indicator lights, a display, such as an LED, LCD or dot-matrix display or any other suitable device for visualization of the security condition set.

The condition indicator device may be of any type to receive said security notification signal from the condition transmitter device. For example, the condition indicator device may according to one embodiment comprise an indicator communication interface for receiving at least the security notification signal. The indicator communication interface may be of any suitable type to receive the security notification signal of the condition transmitter device. The indicator module may in another embodiment be connected with said indicator communication interface.

As mentioned above, the indicator communication interface is adapted to receive the security notification signal from the condition transmitter device and more precisely from the transmitter communication interface. Accordingly, both communication interfaces in one embodiment may be adapted to communicate at least with each other. In another embodiment the condition indicator device is configured to receive security notification signals of a plurality of condition transmitter devices, for example in case of a “centralized” system topology with a central condition indicator device.

In one exemplary embodiment, the communication interfaces are configured for sending and receiving the security notification signal over a wired connection, such as using one or more cable connections between the two communication interfaces. For example, the security notification signal may be provided as a voltage signal over one or more cable connections. Alternatively or additionally to the above, the communication interfaces in one embodiment is configured for sending and receiving the security notification signal over a wireless connection. Reference is made to the networks and protocols discussed in the preceding.

While it should be apparent to one skilled in the art that the transmitter communication interface is at least configured to send the security notification signal and the indicator communication interface is at least configured to receive said security notification signal, resulting in a “one-way” communication link, one or both of the communication interfaces may be adapted in one embodiment for both transmitting and receiving information, i.e., for “two-way” communication, as discussed in more detail in the following.

In the context of the present invention, the term “security notification signal” relates to any analog or digital signal, allowing communication of at least the activated security condition. The security notification signal may certainly comprise further information, such as for example information corresponding to a device or serial number, a room or building number, time and/or date of the activation of the security notification, a still image or video of the respective room or building where the condition transmitter device is installed, additional information entered by the user using, e.g., the user interface or any other information that, depending on the type of emergency, may be helpful for security personnel to improve their response.

The security condition notification system may comprise more than the mentioned condition transmitter device and condition indicator device, as discussed in more detail in the following. Furthermore, embodiments of the present security condition notification system comprise multiple condition transmitter devices and/or condition indicator devices. Such an embodiment could be advantageous in particular in the mentioned context of school security and safety, since here, typically the multiple rooms may require a plurality of condition transmitter and indicator devices for a further improved communication of the security condition of each of the rooms.

Both the condition transmitter device and the condition indicator device may in one embodiment comprise or be integrated with further components, devices, elements, interfaces, units and/or modules. For example, the condition indicator device and/or the condition transmitter device may comprise a computing device, having at least a processor with memory/storage comprising suitable programming/software to provide the functionality discussed in the preceding and also in the following description. The software can include a kernel, operating system and/or a shell or interface. One or more application programs or modules may be “loaded”, i.e. transferred from storage into memory for execution by the processor.

In one embodiment, the user interface of the condition transmitter is configured to enable a user to activate one of at least a first, a second and a third security condition. The user interface may, e.g., comprise three corresponding rocker or key switches, allowing a user to set one of the three security conditions accordingly.

The present invention according to this embodiment advantageously allows communication of at least a third security condition. For example and in the context of school security and safety as mentioned in the preceding, the third security condition may relate to a “Blue Alert Status”, indicating that the respective location is safe but that not all students are accounted for, e.g., that one of the students is currently missing from his class.

According to a further embodiment, the indicator module comprises at least a first, a second and a third indicator light, associated with said first, second and third security condition, respectively. The indicator lights may be of any suitable type, such as incandescent, halogen or LED indicator lights. The embodiment provides a particularly cost efficient setup of the condition indicator module.

In particular in the above mentioned context of school security and safety and in another embodiment, the first indicator light is of red color to show the “Red Alert Status”, the second indicator light is of green color to show the “Green Alert Status” and the third indicator light is of blue color to show the “Blue Alert Status”. The use of colored indicator lights advantageously allows security personnel to quickly assert the security condition of the respective room or building, even at a certain distance from the condition indicator device.

In another exemplary embodiment, the condition transmitter device and/or the condition indicator device comprises a wall-mountable housing. The present embodiment provides that the devices are easily accessible, which may be advantageous in particular in an emergency situation.

The housing may be of any suitable material, including plastic and metal materials. The housing in a further embodiment may be configured to be tamper resistant, to safely accommodate the components of the respective device and keep the system operational at all times. According to an alternative or additional embodiment, the housing may be rain- or water-resistant, which may be useful depending on the installation location. In the latter case, the user interface and/or the indicator lights may comprise elastomeric seals to improve the rain- or water-resistance.

In the above-mentioned example of the condition indicator device having a wall-mountable housing, the housing in a further embodiment accommodates at least said indicator communication interface and/or said indicator module. In the alternative or as an additional example of the condition transmitter device comprising a housing, said housing accommodates at least said user interface and said transmitter interface.

The housing may in both examples comprise further components, devices, elements, interfaces, units and/or modules. For example, the housing of the condition transmitter device may be configured to display a list of security lockdown procedures, so that in an emergency the procedures are close at hand. The housing therefore may, e.g., be provided with a retainer or bracket for attachment of a printed list or comprise a display unit, showing the lockdown procedures on a screen.

In another embodiment, the condition indicator device further comprises an acoustic notification module, configured to provide an acoustic notification at least when said first security condition is activated. As mentioned in the preceding, the first security condition may correspond to a “Red Alert Status”. The present embodiment accordingly allows a further improved notification and thus a quick response of security personnel in a dangerous situation. In the aforesaid context of school security and safety the present invention according to the present embodiment allows an improved notification that there is a problem within the respective location, such as an injured student, and that assistance is urgently required. Depending on the respective application, the acoustic notification module may additionally or alternatively be configured to provide an acoustic notification when said second and/or said third security condition is activated.

The acoustic notification module may be of any suitable type and may comprise a speaker, horn, bell, piezo horn, buzzer or any other suitable device for providing an audible notification when said first security condition is activated. The acoustic notification module in one embodiment is connected with the indicator communication interface.

In a further embodiment, the security condition notification system additionally comprises an image acquisition device for obtaining imaging information. In the present context, the term “imaging information” may refer to photos or videos. In one embodiment, the image acquisition device provides a video stream or signal, e.g., with a corresponding integrated video camera. The image acquisition device may in one embodiment be integrated with said condition transmitter device. Alternatively, the image acquisition device may be provided separately from the condition transmitter device.

The image acquisition device may provide security personnel an “eye” into a classroom, hallway, or entrance area of the building in the event of an emergency, i.e., providing imaging information of the vicinity of the image acquisition device or the condition transmitter device, respectively. The image acquisition device may be configured to transmit said imaging information over a wired or wireless connection. Reference is made to the networks and protocols discussed in the preceding.

The image acquisition device in one embodiment is configured to provide said imaging information to a computing device or a mobile computing device at the site of installation of the security condition notification system, such as in an office. Alternatively or additionally, the image acquisition device may be configured to provide said imaging information to the Internet, so that security personnel can access said information remotely. In a further alternative or additional embodiment, the image acquisition device may be connected with a DVR (digital video recorder).

According to another exemplary embodiment, the image acquisition device is connected at least with said condition transmitter device and is set to be operable when said first security condition is activated. The present embodiment allows automatic activation of the image acquisition device in the case of a “Red Alert Status” security condition.

The image acquisition device may be connected with said condition transmitter device over a wireless or wired connection as mentioned in the preceding. For example, the image acquisition device may comprise a further communication interface, adapted for communication with the transmitter communication interface for receiving said security notification signal. Alternatively, the image acquisition device may be connected with a camera trigger output of the condition transmitter device or of the transmitter communication interface, which is operated when a user activates said first security condition. The security notification system may comprise more than one image acquisition device, e.g., for a better coverage of the respective room, building, hallway, or entrance area that is monitored. The image acquisition device in another embodiment comprises a face recognition module connected with a database of face information. The face recognition module may be configured to match recognized faces with said face information and trigger one of said security notification signals if a match is found. For example, the database may comprise face information of known terrorists. If a match is found, the system automatically informs security personnel that a thread exists in the respective building or campus due to the presence of a terrorist.

In another exemplary embodiment, the system further comprises a locking device, connected with at least said condition transmitter device and configured to lock a door or window at least when said second security condition or said third security condition is activated by the user.

The present invention according to this embodiment allows automatic locking of said door or window when the second or third security condition is set, which corresponds in a school environment to the “Green” or “Blue” Alert Status. This is in particular advantageous during a “lockdown” event, since here, the teachers are typically required to lock the door of the room they are in. Accordingly, the present embodiment facilitates a lockdown.

In a further embodiment, said door or window is locked in case of a “Red Alert Status”, i.e. when said first security condition is activated.

The locking device may be of any suitable type to safely lock the respective door or window. For example, the locking device may comprise a mechanical actuator, which e.g., operates a locking bolt to lock said door or window. Alternatively or additionally, the locking device may be configured for electromagnetic locking using a corresponding magnet. The security condition notification system may comprise more than one locking device, for example in case more than one door or window requires locking.

The locking device may be connected with said condition transmitter device over a wireless or wired connection. Reference is made to the networks and protocols discussed in the preceding.

For example, the locking device may comprise a communication interface, adapted for communication with the transmitter communication interface for receiving said security notification signal. Alternatively, the locking device may be connected with a locking trigger output of the condition transmitter device or of the transmitter communication interface, which is operated when a user activates said second or third security condition.

In a further embodiment, the locking device is formed integrally with said condition transmitter device.

According to another exemplary embodiment, the system additionally comprises a remote activation unit, adapted to enable a user at least to activate said first security condition and configured for transmitting a remote notification signal to said condition transmitter device and/or said condition indicator device. The remote notification signal corresponds to the security condition, as activated by the user using the remote activation unit.

The remote activation unit allows the user to activate the first security condition, corresponding in one example to the “Red Alert Status”, even if the user is not in the direct vicinity of the condition transmitter device. This decreases the time to activate the respective security condition and may be particularly useful when the system is used in a large room, such as a cafeteria or gym.

The remote activation unit may in one example be adapted to provide said remote notification signal to the condition indicator device, either directly or using an intermediate component or device.

The remote activation unit may comprise a remote communication interface, adapted for communication with the transmitter communication interface or the indicator communication interface, depending on the setup of the security notification system. For example, the remote communication interface may configured to send said remote notification signal to the transmitter communication interface of the condition transmitter device, which then may serve as a “relay” and provide the corresponding security notification signal to the condition indicator device and, if present, to any further device of the system.

It is noted that the remote notification signal and the security notification signal may be of the same or different type. In the latter case, the transmitter communication interface may be configured to convert the remote notification signal to the type of the security notification signal so that the condition indicator device may properly display the activated security condition.

In one embodiment, the remote activation unit may additionally or alternatively be configured to allow the user to activate the second and/or the third security condition.

According to another embodiment, the remote activation unit is a portable device. The present embodiment allows for example a teacher to keep the device at hand at all times during class. The portable device in one embodiment may be a key fob, i.e., a device adapted to be carried on a keychain. In particular in case of a portable device, the remote activation unit comprises at least one indicator light to allow the user to verify that the respective security condition has been properly activated. Alternatively or additionally, the remote activation unit in another example may be configured to allow the user to deactivate the previously set security condition.

In a further exemplary embodiment, the remote activation unit is a wall-mountable device. The remote activation unit according to the present embodiment may, e.g., correspond to a “pull station”, i.e., having a lever to activate said first security condition. In another embodiment, the remote activation unit comprises a key lock to deactivate the security condition previously set.

According to a further embodiment, the system additionally comprises a backup battery device, connected at least to said condition transmitter device and to said condition indicator device, to provide said devices with operating power. The present embodiment provides a backup power supply and thus keeps the system operational at all times, even in case of a power mains failure.

The backup battery device may be of any suitable type. In one embodiment of a 24V battery, the backup battery device has a rating of 7 A to 100 A. In case of a 12V backup battery, the backup battery device has a rating of 7 A to 40 A.

Certainly, the backup battery device may be configured to power multiple condition transmitter devices and/or condition indicator or further devices, if present in the system. With a battery rating in the above given exemplary ranges, the backup battery device may be configured to operate three sets of condition transmitter, condition indicator and locking devices, e.g., for three rooms.

In another embodiment, the condition transmitter device comprises an intercom unit, allowing an audio communication at least when one of said security conditions is activated by the user. The present embodiment further improves the communication in an emergency.

The intercom unit may be of any suitable type. For example and in the above-mentioned context of school security and safety, the intercom unit may provide a two-way audio communication between teachers and students in a classroom and security personnel. In particular in the case of the aforementioned image acquisition device, the communication may additionally comprise picture or video information.

In one embodiment, the intercom unit is activated only in case said first security condition is activated, corresponding to a “Red Alert Status”. Certainly, the user interface may also in one example be configured to allow operation of said intercom unit without activation of a security condition.

The intercom unit in one alternative or additional embodiment may be configured to contact security personnel over a wired or wireless connection. Reference is made to the networks and protocols discussed in the preceding. For example, the intercom unit may be configured to connect to a corresponding intercom unit or computing device of security personnel, e.g., over the Internet. In another alternative or additional embodiment, the intercom unit may be provided with a POTS phone connection module or a cellular module for a wireless communication over the cellular network, such as a GSM network, also referred to as “GSM dialer”. The GSM dialer in one example is configured to dial a predefined number of the nearest police department when one of said security conditions is activated. In a further alternative or additional embodiment, the condition indicator device comprises a second intercom unit, configured for communication with said intercom unit of said condition transmitter device.

According to a further embodiment, the transmitter communication interface is additionally configured to transmit a second security notification signal to a further device. For example, the transmitter communication interface may be configured to transmit the second security notification signal to security personnel or to the nearest police department over a wired or wireless connection, as mentioned in the preceding. In another example, the transmitter communication interface may be configured to provide information referring to the activated security condition to security personnel by e-mail or text message (SMS) using an Internet connection and/or the above mentioned phone connection module or said cellular module. Additionally or alternatively, the transmitter communication interface in one example comprises a digital input and output enabling a connection to further/external devices, such as motion sensors, switches, alarm relays or door locks.

The second security notification signal and the first security notification signal may be of the same or different type, depending on the setup of the system.

The present invention according to this embodiment may be particularly advantageous in an exemplary and non-limiting embodiment, where besides the aforementioned condition transmitter device and condition indicator device, a central condition indicator device is provided. A central condition indicator may, e.g., comprise a stationary or mobile computing device with a central indicator communication interface to receive said second security notification signal, and a processing unit, having a respective programming to display the received security condition on a connected display device.

In a further additional embodiment and in case the central condition indicator is configured to receive security notification signals from a plurality of condition transmitter devices, the second security notification signal may comprise identification information, allowing correlation the received security notification signal to a specific condition transmitter device of said plurality and thus to a predefined location, e.g., within the building.

The mentioned central condition indicator device in one example is provided to display the received security condition on a connected display device, installed in an office. In another example, the central condition indicator device comprises multiple display devices. The provision of multiple display devices allows to install a display device at every entrance of the respective building or campus to indicate if a security condition is set and thus if the respective building or campus is safe or unsafe. The multiple display devices may, e.g., be LED indicator poles.

An additional aspect of the present invention relates to a condition transmitter device having at least a user interface, configured to enable a user to activate one of at least a first and a second security condition and a transmitter communication interface, connected with said user interface and configured for transmitting a security notification signal corresponding to the activated security condition to a condition indicator device.

The condition transmitter device according to the present invention provides improved communication in an emergency situation. The condition transmitter device may further be adapted according to one or more embodiments discussed in the preceding or following with reference to the other aspects of the present invention.

Another aspect of the present invention relates to a condition indicator device having at least an indicator module. The condition indicator device is configured to receive a security notification signal from a condition transmitter device, which security notification signal corresponds to one of at least a first and a second security condition. The indicator module is configured to display the security condition of said condition transmitter device, activated by the user.

The condition indicator device may be adapted according to one or more embodiments discussed in the preceding or following. For example, the condition indicator device may comprise an indicator communication interface for receiving said security notification signal and be connected with said indicator module. Alternatively or additionally, the indicator communication interface may be configured to receive security notification signals from a plurality of condition transmitter devices. This may in particular be useful in case the condition indicator device is a “central” condition indicator device.

In a further additional or alternative embodiment, the security notification signal may comprise identification information, allowing correlation of the received security notification signal with a specific condition transmitter device of said plurality and thus with a predefined location, e.g., within the building.

Another aspect of the present invention relates to a method of security condition notification with at least a condition transmitter device and a condition indicator device. The method upon activation of one of at least a first and a second security condition by a user comprises transmitting a security notification signal by the condition transmitter, wherein the security notification signal corresponds to the security condition, activated by the user. Further, the method comprises receiving the security notification signal by said condition indicator device and displaying the security condition of said condition transmitter by the condition indicator device.

Another aspect of the present invention relates to a method of security condition notification with at least a condition indicator device. The method comprises receiving security notification signals from a plurality of condition transmitter devices, wherein the security notification signals correspond to security conditions, activated by the users of said plurality of condition transmitter devices. The method further comprises displaying the security conditions of said plurality of condition transmitter devices by said condition indicator device.

In an additional or alternative embodiment, the security notification signal may comprise identification information, allowing correlation of the received security notification signal to a specific condition transmitter device of said plurality and thus to a predefined location, e.g., within the building.

A computer program or module may be provided to enable a processor to carry out one or more of the methods discussed above. The computer program may be contained on a computer readable medium, such as a solid state, magnetic or optical storage device.

These and other aspects of the invention will be apparent from and elucidated with reference to the embodiments described hereinafter.

### BRIEF DESCRIPTION OF THE DRAWINGS

In the drawings,

FIG. 1 shows a schematic view of a first embodiment of a security notification system according to the present invention,

FIG. 2 shows a perspective view of an embodiment of a condition transmitter device for use in a security notification system,

FIG. 3 shows a perspective view of an embodiment of a condition indicator device for use in a security notification system,

FIG. 4 shows a schematic view of a second embodiment of a security notification system having a plurality of condition transmitter and condition indicator devices,

FIG. 5 shows a front view of an embodiment of a remote activation unit for use in a security notification system,

FIG. 6 shows a perspective view of another embodiment of a remote activation unit for use in a security notification system,

FIG. 7 shows a perspective view of a further embodiment of a condition transmitter device for use in a security notification system,

FIG. 8 shows a perspective view of a further embodiment of a condition transmitter device for use in a security notification system, and

FIG. 9 shows a schematic view of a further embodiment of a security notification system having a plurality of condition transmitter and condition indicator devices.

### DETAILED DESCRIPTION OF PREFERRED EMBODIMENTS

Technical features described in this application can be used to construct various embodiments of security condition notification systems and methods to facilitate response and assistance in an emergency situation.

It has been identified that in the field of security and safety and in particular during a so-called “lockdown” event in a private or public building, e.g., in a school, hospital or other private, public, or government building, it may be problematic for security personnel to assess and control the situation.

In one approach, the present inventor has recognized that a faster and more effective response by security guards, law enforcement or other authorities, collectively “security personnel” hereinafter, is possible by improving the communication of the condition of a room or building in an emergency situation.

By providing a security condition notification system as discussed in the following, communication is improved among those inside a room or building and those outside a room or building. For example during a “lockdown” in a school, typically requiring all interior doors to be kept locked, the inventive system provides an improved communication between, e.g., teachers and students in a classroom and security personnel in a hallway.

Reference will now be made to the drawings, in which the various elements of embodiments will be given numerical designations and in which embodiments will be discussed so as to enable one skilled in the art to make and use the invention.

Specific reference to components, process steps, and other elements are not intended to be limiting. Further, it is understood that like parts bear the same reference numerals, when referring to alternate figures. It will be further noted that the figures are schematic, are provided for guidance to the skilled reader, and are not necessarily drawn to scale. Rather, the various drawing scales, aspect ratios, and numbers of components shown in the figures may be purposely distorted to make certain features or relationships easier to understand.

In the following explanation of the present invention according to the embodiments described, the terms “connected to” or “connected with” are used to indicate a data connection and/or transmission link between at least two components, devices, elements, interfaces, units or modules. Such connection may be direct or indirect, i.e., over intermediate components, devices, elements, interfaces, units and/or modules and may be wired or wireless.

For example, a connection may be provided over a WAN, LAN, cellular network, Bluetooth network, Zigbee network and/or Wi-Fi Network, using a corresponding communications protocol, such as the Internet Protocol.

It is noted that the terms “location”, “room”, “premises” or “space” are used interchangeably in the present specification to denote a specific space in a building. In the context of school security and safety, the above terms may, e.g., relate to a classroom, office, auditorium, conference room, gym, cafeteria, hallway, multi-purpose room, restroom or other any room of a school.

In the context of the present invention, the term “security condition” may relate to any security or safety condition or status applicable to a respective location where the inventive system is used. For example, one of the security conditions may correspond to a “Red Alert Status”, representing a dangerous or unsafe situation. In another example, one of the security conditions may correspond to a “Green Alert Status”, representing a safe situation.

In another example and in the context of school security and safety, the first security condition may relate to a “Red Alert Status”, indicating that there is a problem within the respective location requiring assistance, such as, e.g., an injured student. In a further example in the context of school security and safety, the second security condition may relate to a “Green Alert Status”, indicating that the respective location is safe and that the presence of all students is checked, i.e., that all students are accounted for. A third security condition may relate to a “Blue Alert Status”, indicating that the respective location is safe but that not all students are accounted for, e.g., that one of the students is currently missing from his class.

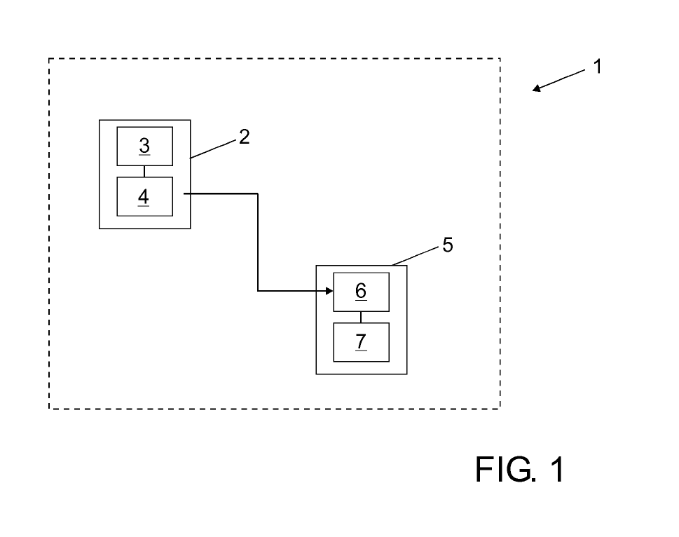

Referring to FIG. 1, a first embodiment of a security notification system 1 is shown in a schematic view. The security notification system comprises at least a condition transmitter device 2 and a condition indicator device 5. The condition transmitter device 2 comprises a user interface 3 and a transmitter communication interface 4.

The user interface 3 allows a user to activate one of at least a first and a second security condition, such as the above mentioned “Red Alert Status” and “Green Alert Status”. The user interface 3 may thus for example comprise one or more corresponding buttons, switches, such as key or rocker switches, a touch screen display, keypad or keyboard or other suitable actuators (not shown) enabling a user to select at least said first or said second security condition. The user interface 3 in one additional or alternative non-limiting embodiment comprises one or more indicators, such as LED lights or a display, to allow the user to verify the selected security condition.

The condition transmitter device 2 may further comprise the transmitter communication interface 4, connected with said user interface 3. According to the present embodiment, the transmitter communication interface 4 is connected with said user interface 3 over a wired connection for receiving the user input.

The transmitter communication interface 4 provides at least a security notification signal to the condition indicator device 5. The security notification signal corresponds to the activated security condition and thus allows the condition indicator device 5 to determine, if and what security condition is activated by the user.

An exemplary condition indicator device 5 according to a non-limiting embodiment comprises an indicator communication interface 6 for receiving said security notification signal over a wired or wireless connection. The condition indicator device 5 may further comprise an indicator module 7, connected to the indicator communication interface 5 and configured to display the security condition of said condition transmitter 2, activated by the user.

The indicator module 7 is configured to display the security condition, as set by the user with the user interface 3 of the condition transmitter device 2. The indicator module 7 may thus comprise, for example, one or more indicator lights, a display, such as an LED, LCD or dot-matrix display or any other suitable device for visualization of the security condition set.

It will be apparent from the above that the security condition notification system 1 according to the present embodiment allows communication of the security condition, set by the user, from the condition transmitter device 2 to the condition indicator device 5. Since both devices are provided separate from each other, improved communication of security conditions from room to room is advantageously enabled even during a “lockdown”, where doors are to be kept locked. Opening of a door or window in such case may pose substantial danger, e.g., during an active shooter or terrorism event.

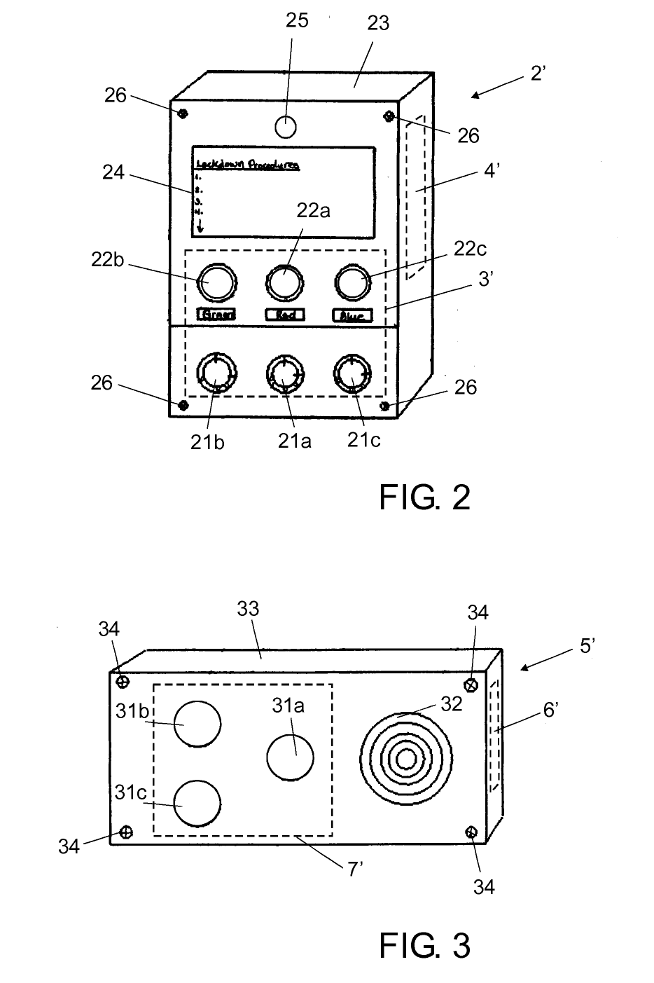

FIG. 2 shows a perspective view of an embodiment of a condition transmitter device 2′ for use in a security notification system 1. The condition transmitter device 2′ comprises the user interface 3′, which according to the present non-limiting embodiment comprises three key switches 21a-21c to allow a user to activate the first, second and third security condition respectively using a corresponding key. It is noted that in one alternative embodiment, the key switches are replaced by other switches, such as rocker switches.

The user interface 3′ further comprises three color coded LED indicator lights 22a-22c, which light up when the corresponding first, second or third security condition is activated and thus allow the user to verify the selection of the correct security condition. The first indicator light 22a is a red LED to indicate a “Red Alert Status”. The second indicator light 22b is a green LED to show a “Green Alert Status”. The third indicator light 22c is a blue LED to indicate a “Blue Alert Status”.

The condition transmitter device 2′ further comprises the transmitter communication interface 4′, which is provided inside of transmitter housing 23 and thus shown only by a dotted line in FIG. 2. The transmitter communication interface 4′ is connected with the user interface 3′ internally over a wire connection (not shown).

The transmitter communication interface 4′ is further connected with the indicator communication interface 6′ of a condition indicator device 5, an embodiment of which is shown in FIG. 3, to provide a security notification signal to the condition indicator device 5′ when a user selects one of the first, second or third security condition.

The condition transmitter device 2′ further comprises a bracket 24 for attachment of, e.g., lockdown procedure instructions of the current school district, as shown, for a quicker response. Furthermore, the condition transmitter device 2′ according to the present embodiment comprises an image acquisition device 25, having a wireless video camera. The video camera is configured to connect to a Wi-Fi network available on site. Other connections, as mentioned in the preceding are possible.

The image acquisition device 25 is activated automatically when the first security condition, corresponding to the “Red Alert Status”, is activated by the user, such as by actuation of key switch 21a. To provide this functionality, the image acquisition device 25 is connected with a camera trigger output (not shown) of the transmitter communication interface 4′.

The image acquisition device 25 is provided to give security personnel an “eye” into the respective room during the event of a code “Red” emergency. The security personnel can access the video camera of image acquisition device 25 over the Internet.

The transmitter housing 23 according to the present non-limiting example has an outward casing, made from plastic material. The housing 23 is wall-mountable. Screws 26 of the housing 23 are of tamper-proof type.

FIG. 3 shows a perspective view of an embodiment of condition indicator device 5′ for use in a security notification system 1. The condition indicator device 5′ according to the present embodiment comprises an indicator communication interface 6′ and an indicator module 7′. Both of the aforesaid components are mounted in indicator housing 33, which according to the present example is a wall-mountable, weatherproof plastic or metal enclosure, having screws 34 of tamper-proof type.

While the indicator communication interface 6′ is arranged inside of indicator housing 33, shown in FIG. 3 by the dotted lines, indicator module 7′ comprises LED indicator lights 31a-31c, visible from the outside of housing 33. The LED indicator lights 31a-31c are color coded, corresponding to LED indicator lights 21a-21c. LED indicator lights 31a-31c are installed in housing 33 with rubber seals for weatherproof protection. Indicator module 7′ is connected with communication interface 6′ internally over a wire connection.

The condition indicator device 5′ further comprises a piezo horn 32, which is activated when the first security condition, corresponding to a “Red Alert Status” is set, to alert the security personnel that immediate assistance is needed.

The operation of security notification system 1 will in the following be explained with reference to an embodiment, comprising condition transmitter device 2′ according to FIG. 2 and condition indicator device 5′ according to FIG. 3. In this example, condition transmitter device 2′ may be installed in a classroom of a school. Condition indicator device 5′ is mounted in the hallway, outside the classroom's door.

In this non-limiting embodiment, said transmitter communication interface 4′ is connected with said indicator communication interface 6′ over three signaling cable connections (not shown). The signaling cable connections allow operation of the respective LED indicator lights 31a-31c and horn 32 of the condition indicator device S′ with a corresponding operating voltage and current of said transmitter communication interface 4′ , when one of the three security notification signals is activated. The security notification signal thus corresponds to a 12V signal. The transmitter communication interfaces 4′, 6′ may in another alternative or additional embodiment be configured for transmission of a digital security notification signal over a wire or wireless connection.

In case an emergency situation is present, a lockdown may be ordered by the security personnel or the headmaster. For example, the lockdown may be announced over the school's public address system. A teacher in the classroom may then, according to the instructions provided in bracket 24, lock the door of the classroom according to the lockdown instructions. Subsequently and after determining whether all students are present, the teacher may set the appropriate security condition using one of the key switches 21a-21c. LED indicator lights 22a-22c will show the selected security condition. Simultaneously, transmitter communication interface 4′ will provide the above voltage signal to indicator communication interface 6′. The respectively connected LED indicator light 31a-31c of the indicator module 7′ will light up correspondingly, allowing security personnel to determine the security condition of this specific classroom from its outside. As mentioned in the preceding, piezo horn 32 is activated only when a “Red Alert Status” is given.

In an embodiment of a security notification system 1, more than one pair of condition transmitter 2 and condition indicator 5 devices, are present. In another embodiment, a plurality of condition transmitter devices 2, are connected with a central condition indicator device 5.

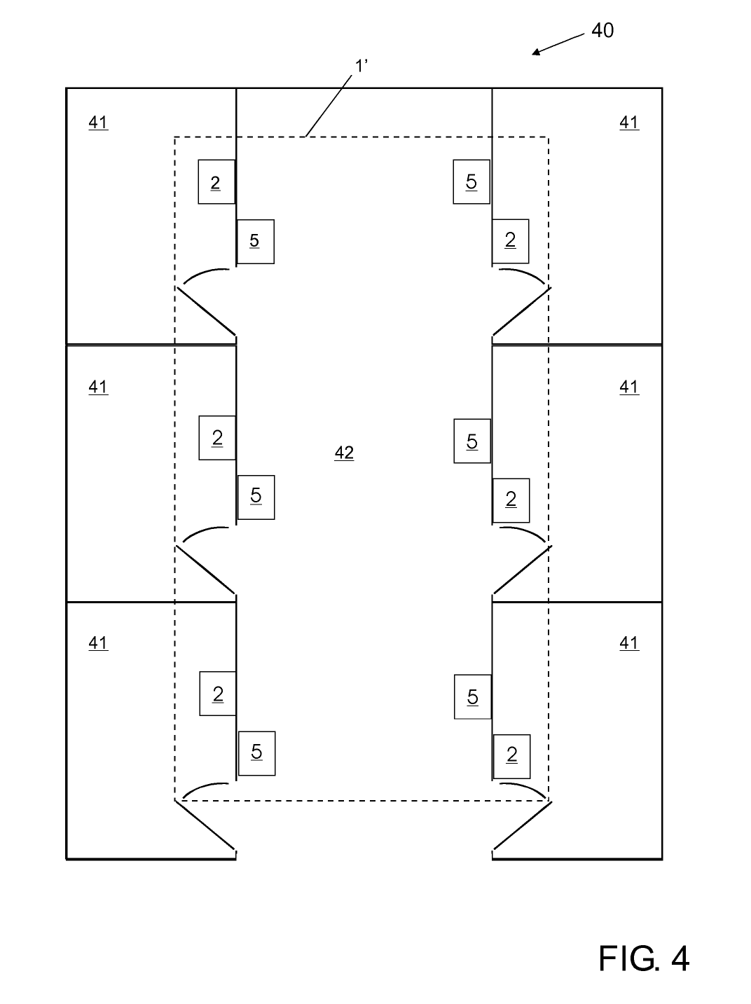

FIG. 4 shows a schematic view of a further embodiment of a security notification system 1′ having a plurality of condition transmitter 2 and condition indicator 5 devices. The figure shows the system 1′ installed in a school 40 (shown in part), having multiple classrooms 41 leading to a common hallway 42. As can be seen from FIG. 4, one condition transmitter 2 is installed in each classroom 41, while the corresponding condition indicator device 5 is installed outside of the respective classroom 41 in the hallway 42. For an easy access, each of the devices 2, 5 are wall-mounted. The condition transmitter device 2 in one example may correspond to the embodiment shown in FIG. 2 and/or any other embodiment described herein. Correspondingly, condition indicator device 5 may in one additional or alternative example correspond to the embodiment shown in FIG. 3 and/or any other embodiment described herein.

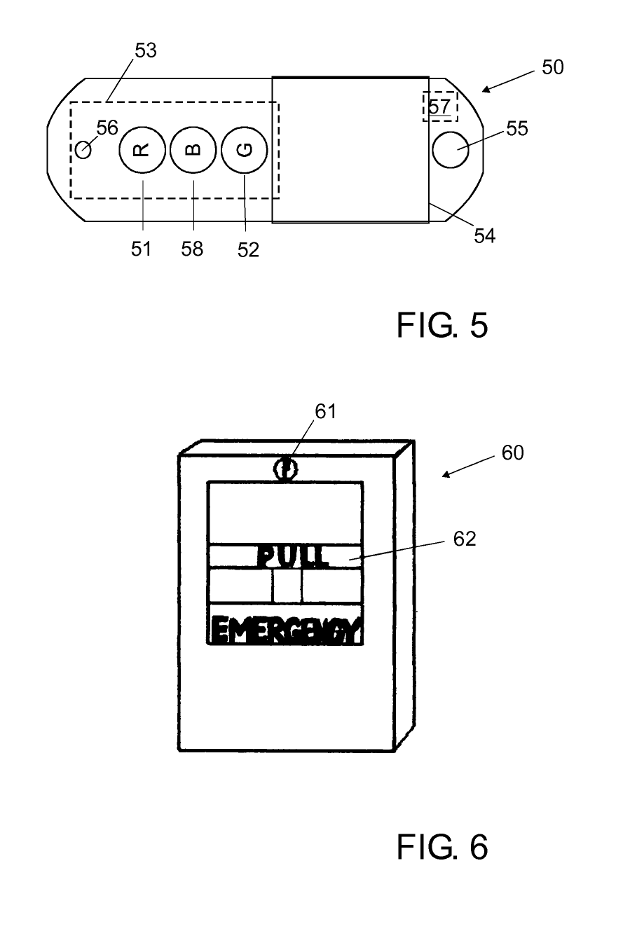

FIG. 5 shows a front view of an embodiment of a remote activation unit 50 for use in a security notification system 1. According to this embodiment, remote activation unit 50 is a portable transmitter, having a hole 55 for attachment to a key ring. The remote activation unit 50 comprises a user interface 53, having three latching-type buttons 51, 52, 58 to activate the first, second and third security condition, respectively, and an multi-color LED indicator 56 to verify the activated security condition. A slidable protective cover 54 is provided to cover buttons 51, 52, 58, e.g., while the remote notification unit 50 is in the pocket of a user to reduce the risk of a false alarm.

Remote activation unit 50 also comprises a wireless communication interface 57. The wireless communication interface 57 is configured to transmit a wireless remote notification signal to condition transmitter device 2. The wireless remote notification signal corresponds to the first security condition. In this embodiment, transmitter communication interface 4 of condition transmitter device 2 is adapted to receive the wireless remote notification signal. According to the present example, the wireless communication interface 57 and the transmitter communication interface 4 are configured for communication in the 433 MHz ISM radio band having three channels, so that each of the security conditions uses one channel.

Upon activation of one of the security conditions using the portable remote activation unit 50, a corresponding wireless remote notification signal is transmitted to the condition transmitter device 2. The transmitter communication interface 4 upon reception of the signal acts as a relay and provides a corresponding security notification signal to the condition indicator device 5. In case the remote activation unit 50 is used in conjunction with condition transmitter device 2′ according to the embodiment shown in FIG. 2, the transmitter communication interface 4′ simultaneously activates LED indicator light 22a of the user interface 3′.

FIG. 6 shows a perspective view of another embodiment of a remote activation unit 60 for use in a security notification system 1. The remote activation unit 60 is a wall-mountable “pull-station” comprising an activation lever 62. According to the present embodiment, the remote activation unit 60 allows a user to activate said first security condition in an emergency. Key lock 61 allows to reset the activated security condition with a corresponding key.

The remote activation unit 60 is connectable with the transmitter communication interface 4 over a wire connection to transmit a wire remote notification signal to the condition transmitter device 2, which triggers the corresponding security notification signal being sent, as explained in the preceding. It is noted that the security notification signal, the wireless remote notification signal and the wire remote notification signal may be of the same or different type. In the latter case, conversion of the signals is provided by the transmitter communication interface 4.

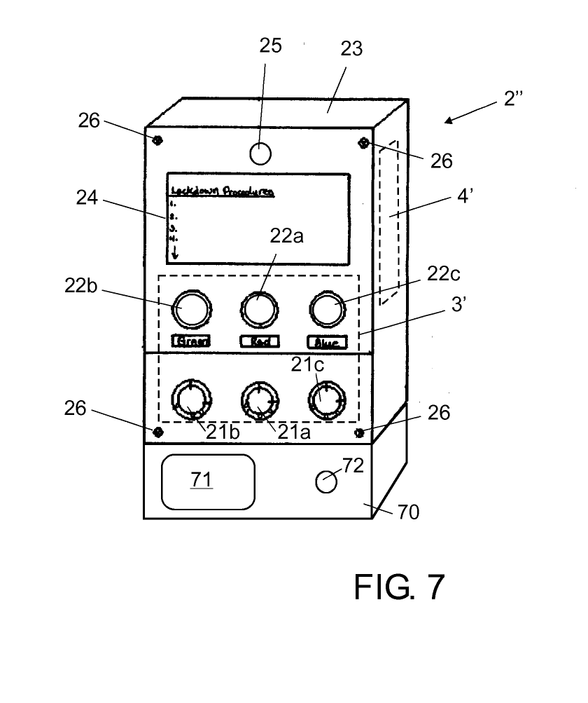

FIG. 7 shows a perspective view of a further embodiment of a condition indicator device 2″ for use in a security notification system 1. The present embodiment corresponds to the embodiment shown in FIG. 2 with the exception of intercom unit 70. The intercom unit 70 comprises a speaker 71 and microphone 72 to enable a two-way audio communication among, in the context of school security and safety, teachers and students inside a room with security personnel. The intercom unit 70 is activated automatically when said first security condition is activated, e.g., using user interface 3′, button 51 or lever 62. To provide this functionality, the intercom unit 70 is connected with transmitter communication interface 4′ over an internal trigger output of interface 4′ (not shown).

Intercom unit 70 comprises a cellular module (not shown) to contact the security personnel over a cellular network. In one example, the cellular module is configured to contact the nearest police department.

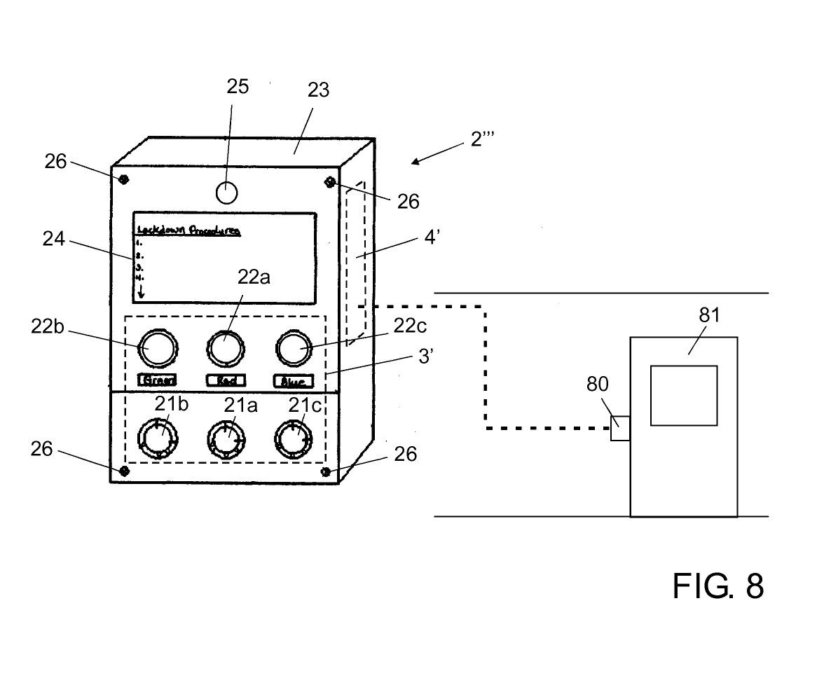

FIG. 8 shows a perspective view of a further embodiment of a condition transmitter device 2′″ for use in a security notification system 1. FIG. 8 shows the condition transmitter device 2′″ in conjunction with a classroom door 81. The present embodiment corresponds to the embodiment shown in FIG. 2 with the exception of locking device 80. Locking device 80 comprises an electromagnetic door lock and is connected with a locking trigger output of the transmitter communication interface 4′. Locking device 80 is configured to automatically lock the classroom door 81 when the user activates the second or third safety condition, i.e., corresponding to the “Green Alert Status” or the “Blue Alert Status”. This is in particular advantageous during a lockdown, since here, the teachers are typically required to lock the door of the room they are in.

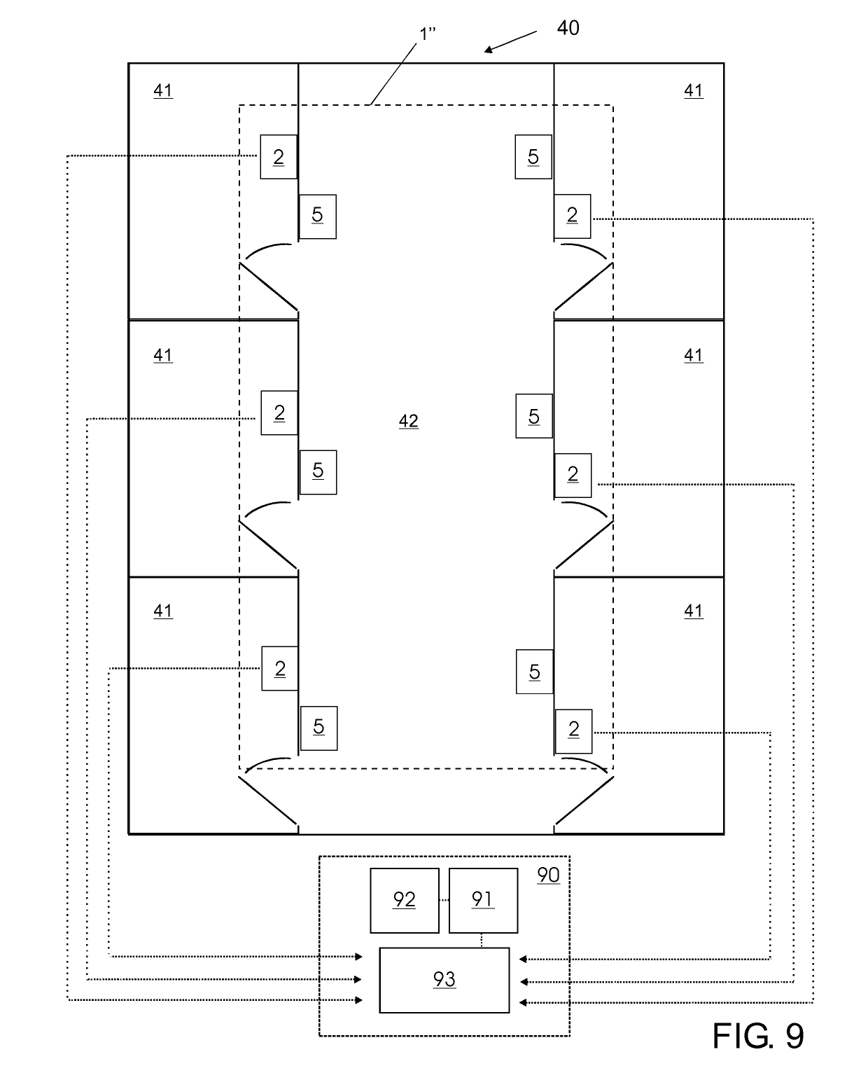

FIG. 9 shows a schematic view of a further embodiment of a security notification system 1″ having a plurality of condition transmitter devices 2 and condition indicator devices 5. The embodiment of FIG. 9 corresponds to the embodiment of FIG. 4, with the exception of an additional central condition indicator device 90. The central condition indicator device 90 in the present, non-limiting embodiment is a computing device with a processor unit 91, display unit 92 and central indicator communication interface 93. The central condition indicator device 90 comprises a respective programming to receive security notification signals from a plurality of condition transmitter devices 2 and to display the corresponding security conditions on display unit 92.

According to the present embodiment, the transmitter communication interfaces 4 (not shown in FIG. 9) of the condition transmitter devices 2 are configured to provide secondary security notification signals to the central indicator communication interface 93 over a wireless connection, such as a Wi-Fi connection. The secondary security notification signals, provided by the transmitter communication interfaces 4, correspond to the respectively selected security conditions of condition transmitter devices 2 and further comprise in the present non-limiting example identification information, allowing correlating of the received security notification signal to a specific condition transmitter device 2 and thus a specific one of the rooms 41. The present embodiment allows security personnel to determine the security conditions of each room 41 from a security or headmaster office or a remote police station.

While the invention has been illustrated and described in detail in the drawings and foregoing description, such illustration and description are to be considered illustrative or exemplary and not restrictive; the invention is not limited to the disclosed embodiments. The mere fact that certain measures are recited in mutually different dependent claims does not indicate that a combination of these measured cannot be used to advantage.

Other variations to the disclosed embodiments can be understood and effected by those skilled in the art in practicing the claimed invention, from a study of the drawings, the disclosure, and the appended claims. For example, an embodiment is conceivable, wherein
instead of bracket 24, the condition transmitter device 2, 2′, 2″, 2′″ comprises a display unit for providing information to the user, such as lockdown procedure instructions of, e.g., the current school district,
instead of the LED indicator lights 22a-22c, 31a-31c, one or more display units, such as an LED, LCD or dot-matrix display, are provided to display the activated security condition,
in the embodiments of FIGS. 2, 7 and/or 8, the image acquisition device 25 is provided external to housing 23,
in the embodiments of FIGS. 2, 7 and/or 8, the image acquisition device 25 comprises a face recognition module connected with a database of face information,
in the embodiments of FIGS. 2, 7 and/or 8, the image acquisition device 25 is connected with a video recording unit such as a digital video recorder instead of being connected with the Internet,
in the embodiment of FIG. 3, the condition indicator device 5′ comprises instead of piezo horn 32, a different type of acoustic notification module,
in the embodiments of FIGS. 1, 2, 4, 7 and/or 8, the transmitter communication interface 4, 4′ is configured to additionally transmit a second security notification signal to a further device, such as a central condition indicator device, a computing device, or phone, e.g., of security personnel by e-mail or text message
in the embodiments of FIGS. 1, 2, 4, 7 and/or 8, the transmitter communication interface 4, 4′ comprises a digital input and/or output enabling a connection to an external device, such as a motion sensor, switch, alarm relay or door lock,
the system 1, 1′, 1″ comprises a backup battery device, connected at least with the condition transmitter device 2, 2′, 2″, 2′″ and the condition indicator device 5, 5′ to provide said devices with operating power,
in the embodiments of FIGS. 5 and/or 6, the remote activation units 50, 60, instead of being connected with said condition transmitter device 2, 2′, 2″, 2′″, being connected with the indicator communication interface 6, 6′ of said condition indicator device 5, 5′,
in the embodiment of FIG. 9, multiple display units 92, such as LED indicator poles, are provided at each entrance (not shown) of school 40 to indicate if a security condition is set and thus if the building is safe to enter, and/or
the intercom unit 70, instead of comprising the cellular module, is configured to connect to provide audio communication with a corresponding second intercom unit or computing device, over a wired or wireless connection, such as or over a phone line or Internet connection.

In the claims, the word “comprising” does not exclude other elements or steps, and the indefinite article “a” or “an” does not exclude a plurality. A single processor, module or other unit may fulfill the functions of several items recited in the claims.

A computer program may be stored/distributed on a suitable medium, such as an optical storage medium or a solid-state medium supplied together with or as part of other hardware, but may also be distributed in other forms, such as via the Internet or other wired or wireless telecommunication systems.

What is claimed is:

1. Security condition notification system, comprising at least a condition transmitter device and a condition indicator device, wherein
said condition transmitter device has at least
a user interface, configured to enable a user to activate one of at least a first and a second security condition and
a transmitter communication interface connected with said user interface and configured for transmitting a security notification signal corresponding to the activated security condition to said condition indicator device and
said condition indicator device is configured for receiving said security notification signal and comprising at least
an indicator module, configured to display the security condition of said condition transmitter device, activated by the user.

2. Security condition notification system according to claim 1, wherein the user interface of the condition transmitter device is configured to enable a user to activate one of at least a first, a second and a third security condition.

3. Security condition notification system according to claim 1, wherein the indicator module comprises at least a first, second and third indicator light, associated with said first, second and third security condition, respectively.

4. Security condition notification system according to claim 1, wherein the condition transmitter device and/or the condition indicator device comprises a wall-mountable housing.

5. Security condition notification system according to claim 1, wherein said condition indicator device further comprises an acoustic notification module, configured to provide an acoustic notification when said first security condition is activated.

6. Security condition notification system according to claim 1, wherein said system further comprises an image acquisition device for obtaining imaging information.

7. Security condition notification system according to claim 6, wherein said image acquisition device is connected at least with said condition transmitter device and is set to be operable when said first security condition is activated.

8. Security condition notification system according to claim 6, wherein said image acquisition device is formed integrally with said condition transmitter device.

9. Security condition notification system according to claim 7, wherein said image acquisition device is formed integrally with said condition transmitter device.

10. Security condition notification system according to claim 2, wherein said system further comprises a locking device, connected with said condition transmitter device, and is configured to lock a door or window at least when said second security condition or said third security condition is activated by the user.

11. Security condition notification system according to claim 1, wherein said system additionally comprises a remote activation unit, adapted to enable a user to activate at least said first security condition, and is configured for transmitting a remote notification signal to said condition transmitter device and/or said condition indicator device, which remote notification signal corresponds to the activated security condition.

12. Security condition notification system according to claim 11, wherein said remote activation unit is a portable device.

13. Security condition notification system according to claim 11, wherein said remote activation unit is a wall-mountable device.

14. Security condition notification system according to claim 1, wherein the system further comprises a backup battery device, connected at least to said condition transmitter device and said condition indicator device to provide said devices with operating power.

15. Security condition notification system according to claim 1, wherein said condition transmitter device comprises an intercom unit, said intercom unit is configured to provide an audio communication when one of said security conditions is activated.

16. Security condition notification system according to claim 1, wherein said transmitter communication interface is configured to transmit a second security notification signal to a further device.

17. Condition transmitter device for use in a security condition notification system, comprising at least
a user interface, configured to enable a user to activate one of at least a first and a second security condition and
a transmitter communication interface connected with said user interface and configured for transmitting a security notification signal corresponding to the activated security condition to a condition indicator device.

18. Condition indicator device for use in a security condition notification system, said condition indicator device being configured for receiving a security notification signal from a condition transmitter device, wherein said security notification signal corresponds to one of at least a first and a second security condition, said condition indicator device comprising at least an indicator module, configured to display the security condition of said condition transmitter device, activated by the user.

19. Condition indicator device according to claim 18, configured to receive security notification signals from a plurality of condition transmitter devices.

20. Method of security condition notification with at least a condition transmitter device and a condition indicator device, the method comprising upon activation of one of at least a first and a second security condition by a user:
transmitting a security notification signal by the condition transmitter device, the security notification signal corresponding to the security condition activated by the user,
receiving the security notification signal by said condition indicator device and
displaying the security condition of said condition transmitter by the condition indicator device.

21. Method of security condition notification with at least a condition indicator device, comprising
receiving, by the condition indicator device, security notification signals from a plurality of condition transmitter devices, said security notification signals corresponding to security conditions activated by the users of said plurality of condition transmitter devices and
displaying, by the condition indicator device, the security conditions of said plurality of condition transmitter devices.

22. A computer-readable medium including contents that are configured to cause a computing system to provide a security condition notification by performing a method comprising
receiving security notification signals from a plurality of condition transmitter devices, said security notification signals corresponding to security conditions activated by the users of said plurality of condition transmitter devices and
displaying the security conditions of said plurality of condition transmitter devices.
